(19) United States
(12) Patent Application Publication
(10) Pub. No.: US 2025/0229870 A1
(43) Pub. Date: Jul. 17, 2025

(54) SINGLE SHARED ANCHOR MOORING SYSTEMS AND INSTALLATION METHOD FOR FLOATING OFFSHORE WIND TURBINES

(71) Applicant: JIN WANG, HOUSTON, TX (US)

(72) Inventor: JIN WANG, HOUSTON, TX (US)

(73) Assignee: JIN WANG, HOUSTON, TX (US)

(21) Appl. No.: 18/414,286

(22) Filed: Jan. 16, 2024

(51) Int. Cl. B63B 21/50; B63B 35/44; F03D 13/25

(52) U.S. Cl. CPC B63B 21/50; F03D 13/25; B63B 2035/446

(57) ABSTRACT

Two types of single shared anchor mooring systems and installation method for station-keeping of floating offshore wind turbines are disclosed. The first type has one anchor on the seabed, a plurality of mooring lines, three-dimensional fairlead devices, and pendent gravity units. Each of the mooring lines runs from a first end attached to the corresponding pendent gravity unit suspended in mid-water vertically upward through the corresponding three-dimensional fairlead device attached to the floater and extends downward to a second end attached to the anchor. The mooring line has a constant tension equal to the submerged weight of the pendent gravity unit. The second type has one anchor on the seabed, one pendent gravity unit suspended in mid-water above the anchor, a plurality of mooring fairleads and interconnected mooring lines. Each of the mooring lines runs upward from a first end connected to the anchor through the mooring fairlead attached to the floater and extends downward to a second end connected to the pendent gravity unit. The mooring systems are secured to the floater at quayside, towed-out with the floater, and installed by lowering the anchor and the pendent gravity units under gravity at the offshore site.

### CROSS-REFERENCE TO RELATED APPLICATIONS

This present application claims the benefits of priority from the U.S. non-provisional application Ser. No. 17/971,513 (Confirmation No. 7546), entitled “SINGLE SHARED ANCHOR MOORING SYSTEMS AND INSTALLATION METHOD FOR FLOATING OFFSHORE WIND TURBINES”, filed on Oct. 21, 2022.

### STATEMENT REGARDING FEDERALLY SPONSORED RESEARCH OR DEVELOPMENT

Not applicable.

### REFERENCES

### U.S. Patent Documents

U.S. Pat. No. 7,819,073 B2, Sveen et al., October 2010
U.S. Pat. No. 8,689,721 B2, Wang, April 2014
U.S. Pat. No. 8,692,401 B2, Roddier et al., April 2014
U.S. Pat. No. 9,139,266 B2, Roddier et al., September 2015
U.S. Pat. No. 9,394,035 B2, Dagher et al., July 2016
U.S. non-provisional application Ser. No. 17/681,744, Wang, Feb. 26, 2022

### OTHER PUBLICATIONS

International Renewable Energy Agency (IRENA), “Floating Foundations: A Game Changer for Offshore Wind Power”, 2016.
Office of Energy Efficiency and Renewable Energy, U.S. Department of Energy (DOE), “Offshore Wind Market Report-2021 Edition”, August 2021.
Journal of Ocean Engineering, Elsevier, “Design and comparative analysis of alternative mooring systems for floating wind turbines in shallow water with emphasis on ultimate limit state design”, Volume 219, January 2021.
Proceedings of the ASME 2021 40th International Conference on Ocean, Offshore and Arctic Engineering, “Mooring Designs for Floating Offshore Wind Turbines Leveraging Experience from the Oil & Gas Industry”, June 2021.

### FIELD OF INVENTION

Embodiments of present invention relate generally to the field of floating offshore wind turbines for wind power generation. More specifically, embodiments of present invention relate to mooring systems and installation method for station-keeping of floating offshore wind turbines.

### BACKGROUND OF THE INVENTION

Offshore wind power has become a main source of renewable energy. Presently, most of the offshore wind power is generated using wind turbines with wind power generation capacity less than 10 MW supported by fixed bottom foundations in water depth less than 60 meters. As the demand for offshore wind power increases, there are growing needs to deploy large wind turbines supported by floating foundations in water depth greater than 60 meters where conventional fixed bottom foundations become less attractive economically compared with floating foundations for large wind turbines with wind power generation capacity greater than 10 MW. In recent years, several novel concepts of floating offshore wind turbine foundations have been invented. Examples of such inventions are U.S. Pat. No. 7,819,073B2 (2010), U.S. Pat. No. 8,689,721B2 (2014), U.S. Pat. No. 8,692,401B2 (2014), U.S. Pat. No. 9,139,266B2 (2015), and U.S. Pat. No. 9,394,035B2 (2016). Some of these novel concepts have been or are being deployed to offshore wind farms for commercial power generation in water depth from 60 meters to 300 meters and beyond according to industry and government publications.

Mooring systems are used for station-keeping of a floater such as a floating offshore wind turbine in an acceptable range within its initial equilibrium position. A mooring system generally consists of several mooring lines spreading radially outward in a symmetrical fashion from the floater to the anchors on the seabed. In contrast to the technological innovations and advancement in floating offshore wind turbine foundations, mooring system technologies for station-keeping of floating offshore structures have not advanced significantly in many decades. Presently, the catenary mooring system is the most widely used station-keeping system in the offshore industry for floating oil and gas platforms as well as floating offshore wind turbine foundations. The catenary configuration of the mooring line provides the horizontal restraining force through the weight of the steel chain and wire suspended in the water as the floater having a horizontal offset from its initial equilibrium position.

Traditionally, water depth above 305 meter (1000 feet) is considered as deep water and 150 meters or below as shallow water for offshore oil and gas production in the offshore industry. It is known that the prior art conventional catenary mooring systems have significant shortcomings and technical challenges for floating offshore wind turbines in shallow water, and the problem gets worse as the water depth gets shallower and the suspended catenary section of the mooring line gets shorter. Specifically, for a catenary mooring system to restrain a floating offshore wind turbine in an acceptable range within its initial equilibrium position in shallow water, the mooring line length required usually exceeds 10 times of the water depth resulting in long and costly mooring lines. For example, the mooring line length of a catenary mooring system could be more than 800 meters for a floating offshore wind turbine in a water depth of 60 meters.

FIG. 1A illustrates a front view of an exemplary floating offshore wind turbine with a catenary mooring system in approximately 60 m water depth according to the prior art, with the mooring line length on the seabed truncated for clarity. FIG. 1B illustrates the same front view of the floating offshore wind turbine shown in FIG. 1A with the catenary mooring line drawn to scale on the right side showing a very long mooring line on the seabed. FIG. 2A illustrates a top view of the floating offshore wind turbine shown in FIG. 1A with a catenary mooring system consisting of three mooring lines and three anchors with the mooring line length truncated for clarity. FIG. 2B illustrates the same top view of the floating offshore wind turbine shown in FIG. 2A with the catenary mooring system drawn to scale showing a very large mooring footprint on the seabed.

The existing catenary mooring systems according to the prior art are length constraint, i.e., the physical length of the mooring line between the first end at the fairlead on the floater and the second end at the anchor on the seabed is fixed even though the mooring line configuration, e.g., the shape of the catenary curve, will vary with water depth and pre-tension. For a length constraint mooring system, the tension force in the mooring line increases as the horizontal offset of the floater increases due to ocean environmental forces from wind, wave and current. For a typical floating offshore wind turbine moored in the ocean using the conventional catenary mooring system, the tension force in the mooring line is dynamic and position dependent. The mooring line tension force can increase exponentially from 1,000 KN at the initial position to well over 10,000 KN as the horizontal offset of the floater increases, particularly near the maximum offset when the mooring line is becoming a nearly straight line from the initial catenary configuration. This dynamic effect gets worse in shallow water due to the limited water column for the suspended catenary part of the mooring line to accommodate the relatively large horizontal offset of the floater. It is this exponentially increasing tension force that causes significant technical challenges in catenary mooring system design with high risks of potential strength and fatigue failure. Because of the highly dynamic nature of the mooring line tension force, the mooring line size for the conventional catenary mooring system is usually quite large, and often redundant lines are required for safety considerations resulting in increased material cost, installation difficulties and supply-chain challenges.

The shortcomings of the conventional catenary mooring systems make large scale deployment of floating offshore wind turbines less economical and technically challenging, particularly for shallow water of less than 100 meters and deep-water of greater than 300 meters. In addition, the large mooring footprint on the seabed is not friendly to the ocean environment as it may cause hazards to marine wildlife and fishery.

There remains a strong need for new mooring systems to overcome the shortcomings of existing mooring systems and reduce cost for the floating offshore wind industry.

### SUMMARY OF THE INVENTION

The present disclosure provides single shared anchor mooring systems and installation method for station-keeping of floating offshore wind turbines with small footprint on the seabed, minimum impact on marine environment, much better safety, and significantly lower cost than existing mooring systems. Two types of mooring systems are disclosed.

The first type is a constant tension single shared anchor mooring system comprising a single anchor on a seabed and at least three mooring lines with constant mooring line tension. In some embodiments as shown in FIG. 4, the constant tension single shared anchor mooring system comprises an anchor fixed to the seabed, an anchor head structure coupled to a top of the anchor; a plurality of mooring lines, three-dimensional fairlead devices, anchor padeyes, pendent gravity units and fairlead supports; and a floating hull having an upper part supporting the wind turbine above a waterline and a lower part below the waterline to which the fairlead devices are attached. Each of the mooring lines has one end attached to a corresponding pendent gravity unit and runs vertically upward through the corresponding fairlead device then extending radially downward to a second end attached to a corresponding anchor padeye on the anchor head structure located in a center of a mooring pattern which is an intersection of a vertical centerline of the floating hull and the seabed. Each of the pendent gravity unit is suspended under gravity in mid-water below the fairlead device attached to the lower part of the floating hull causing a tension force in the mooring line equal to the submerged weight of the pendent gravity unit. In contrast to the prior art mooring systems with dynamically varying mooring line tension and fixed mooring line length between the mooring fairlead attached to the floating hull and the anchor on the seabed, the present invention as shown in FIG. 5 has a constant mooring line tension and a varying mooring line length between the fairlead device attached to the floating hull and the anchor on the seabed when the floater has a horizontal offset from its initial position. Specifically, the fairlead device includes a plurality of fairleads each having a wheel with a grooved rim around which the mooring line runs through from one side to another side acting to change the direction of the tension force applied to the mooring line while maintaining a constant magnitude of the tension force according to the pulley principle in physics. The magnitude of the tension force of the mooring line on both sides of the fairlead wheel equals to the submerged weight of the pendent gravity unit connected to one end of the mooring line suspended in mid-water.

The second type is an interconnected lines single shared anchor mooring system comprising a single anchor on the seabed and at least three interconnected mooring lines and one pendent gravity unit suspended under gravity in mid-water. In some embodiments as shown in FIG. 13, the interconnected lines single shared anchor mooring system comprises an anchor on a seabed, an anchor head structure coupled to a top of the anchor; one pendent gravity unit, a plurality of mooring lines, mooring fairleads, mooring padeyes, anchor padeyes and fairlead supports; and a floating hull having an upper part above a waterline supporting the wind turbine and a lower part below the waterline to which the mooring fairleads are attached. Each of the mooring lines has one end attached to the pendent gravity unit suspended in mid-water below the floating hull and above the anchor and runs radially upward through a corresponding mooring fairlead then extending radially downward to a second end attached to the anchor head structure located in a center of a mooring pattern which is an intersection of a vertical centerline of the floating hull and the seabed. In contrast to the prior art mooring systems with fixed mooring line length between the mooring fairlead attached to the floating hull and the anchor on the seabed, the present invention as shown in FIG. 14 has a varying mooring line length between the mooring fairlead attached to the floater and the anchor on the seabed due to the interconnected mooring lines with shared total mooring line length when the floater has a horizontal offset from its initial position. Specifically, for example, when the length of one mooring line of the interconnected mooring system increases, the length of the other mooring line will decrease assuming a two-line mooring system. Since the mooring lines are interconnected at the pendent gravity unit, the sum of the vertical component forces of the tension forces in the interconnected mooring lines at the pendent gravity unit always equals to the submerged weight of the pendent gravity unit regardless the offset position of the floating hull and the number of mooring lines.

The anchor of the above two types of shared anchor mooring systems can be suction type made of steel material or gravity type made of concrete material. The mooring lines can steel chains, steel wires, or synthetic ropes.

A Method for installing the aforementioned two types of single shared anchor mooring systems is disclosed. Conventional method of mooring system installation in accordance with prior art is to install the anchors in one offshore operation before the arrival the floater, then install the mooring lines and connect the mooring lines to the floater when the floater is in-place during a second offshore operation. The present disclosed installation method is to install the anchor and the mooring lines together with the floater in one offshore operation. In some embodiments as shown in FIG. 18 to FIG. 21, the anchor with the mooring lines and the pendent gravity units are pre-connected and secured to the floater at quayside, towed-out to the offshore wind farm site, the anchor is first released and lowered to the seabed, then the pendent gravity units are released and lowered to mid-water with the mooring lines tensioned automatically by the submerged weight of the pendent gravity unit.

In summary, the single shared anchor mooring systems (the constant tension type, and the interconnected lines type) and installation method in accordance with the present disclosure have distinct features providing technical feasible, environmental-friendly, and low-cost solutions for the problems of the prior art conventional mooring systems and technologies, such as the widely used catenary mooring system and technology, for station-keeping of floating offshore wind turbines in water depth from 50 meters to more than 1500 meters.

First, from physics point of view, there are two fundamental variables for a mooring line, i.e., the mooring line length and tension. All existing mooring systems (catenary, taut, tension leg, etc.) currently used in the marine/offshore industry for station-keeping are based on the conventional “length-fixed” theory. Specifically, the mooring line length is fixed between the two ends (the fairlead on the floater and the anchor on the seabed), and the mooring line tension varies (increases) as the floater moves away from its initial equilibrium position. The present invention represents a fundamental breakthrough from the conventional “length-fixed” mooring theory with a new “length-varying” theory. This theoretical breakthrough resulted in the invention of the two new types of mooring systems, one is the “length-varying and tension-constant” type, and the other is the “length varying and tension varying” type. Second, various other novel mooring systems can also be designed for different offshore applications based on this new mooring theory. For example, a multi-anchor constant tension mooring system or a single shared anchor mooring system with new configurations and mechanism different from the present inventions. Third, the two types of single shared anchor mooring systems have the smallest footprint (just one anchor) on the seabed, and smallest disturbed ocean water volume from the anchor to floater, thus the smallest possible adverse impact on the marine environment. This is particularly significant for deep water. For example, for a floater in 1000 meters water depth, the radius of the mooring footprint of a conventional taut catenary mooring system will be more than 1500 meters on the seabed, resulting in over 7.38 billion cubic meters of disturbed ocean water volume. In contrast, a single shared anchor mooring system will have about 4.96 million cubic meters of disturbed ocean water volume, less than 1/1000 of the conventional mooring system. Fourth, the cost of a single shared anchor mooring system is much less (about ⅓) than a conventional catenary mooring system. Fifth, the single shared anchor mooring systems can be installed with the floater during one offshore operation utilizing regular tugboats without specialized tensioning equipment and subsea mooring connectors. In contrast, a conventional catenary mooring system will need to have two offshore installation operations to install the whole system using specialized anchor handling vessels, mooring line tensioning equipment and subsea connectors. Sixth, the single shared anchor mooring systems have much smaller (zero for the constant tension system) dynamic tension in the mooring lines, resulting in significantly increased safety, reliability, and fatigue life compared with the existing mooring systems including catenary mooring and tension leg mooring systems.

In addition to the above advantages, it is highly feasible to economically fabricate the anchors and pendent gravity units of the single shared anchor mooring systems utilizing local resources thus creating new jobs and other benefits for the local community.

### BRIEF DESCRIPTION OF DRAWINGS

FIG. 1A is a schematic front view of an exemplary floating offshore wind turbine in approximately 60 m water depth having a conventional catenary mooring system according to the prior art with mooring line length truncated for clarity.

FIG. 1B is a schematic front view of the floating offshore wind turbine shown in FIG. 1A with mooring line length drawn to scale on the right side.

FIG. 2A is a schematic top view of the floating offshore wind turbine shown in FIG. 1A having three mooring lines and three anchors with mooring line length truncated for clarity.

FIG. 2B is a schematic top view of the floating offshore wind turbine shown in FIG. 2A with mooring line length drawn to scale.

FIG. 3 is a schematic side view of an exemplary embodiment of a floating offshore wind turbine with a constant tension single shared anchor mooring system in a shallow water in accordance with the present invention.

FIG. 4 is a schematic perspective view of an exemplary embodiment of a floating offshore wind turbine with a constant tension single shared anchor mooring system with three mooring lines.

FIG. 5 is a schematic side view of an embodiment of the floating offshore wind turbine with the constant tension single shared anchor mooring system shown in FIG. 3 at a maximum horizontal offset.

FIG. 6 is a schematic detailed side view of an embodiment of a mooring line running through a three-dimensional fairlead device with a pendent gravity unit suspended below in an offset plane.

FIG. 7 is a schematic detailed perspective view of a mooring line running through a three-dimensional fairlead device with three wheels with the pendent gravity unit suspended below in an offset plane.

FIG. 8 is a detailed prospective view of an embodiment of a gravity anchor with three mooring padeyes as part of an anchor head structure.

FIG. 9 is a detailed prospective view of an embodiment of a suction anchor with three mooring padeyes as part of an anchor head structure.

FIG. 10 is a detailed top view of the three mooring padeyes as part of the anchor head structure.

FIG. 11 is a schematic perspective view of an exemplary embodiment of a floating offshore wind turbine with a constant tension single shared anchor mooring system in a deep water.

FIG. 12 is a schematic side view of an embodiment of the floating offshore wind turbine in a deep water with the constant tension single shared anchor mooring system moving from an initial equilibrium position to a position at a maximum horizontal offset.

FIG. 13 is a schematic side view of an exemplary embodiment of a floating offshore wind turbine with an interconnected lines single shared anchor mooring system in a shallow water.

FIG. 14 is a schematic side view of an embodiment of the floating offshore wind turbine with the interconnected lines single shared anchor mooring system shown in FIG. 13 at a position with maximum horizontal offset.

FIG. 15 is a schematic detailed side view of an embodiment of a mooring line running through a fairlead wheel with interconnected mooring lines and a pendent gravity unit.

FIG. 16 is a schematic detailed perspective view of mooring padeyes for the interconnected mooring lines with a pendent gravity unit suspended below in mid water.

FIG. 17 is a schematic perspective view of an exemplary embodiment of a floating offshore wind turbine with an interconnected lines single shared anchor mooring system.

FIG. 18 is a schematic perspective view of an exemplary embodiment of a floating offshore wind turbine with a constant tension single shared anchor mooring system in a pre-installation configuration in accordance with the present invention.

FIG. 19 is a schematic perspective view of an exemplary embodiment of the floating offshore wind turbine with the constant tension single shared anchor mooring system in a pre-installation configuration being towed by a tugboat.

FIG. 20 is a schematic perspective view of an exemplary embodiment of the floating offshore wind turbine with the constant tension single shared anchor mooring system during lowering installation of the anchor.

FIG. 21 is a schematic perspective view of an exemplary embodiment of the floating offshore wind turbine with the constant tension single shared anchor mooring system during lowering installation of the pendent gravity units.

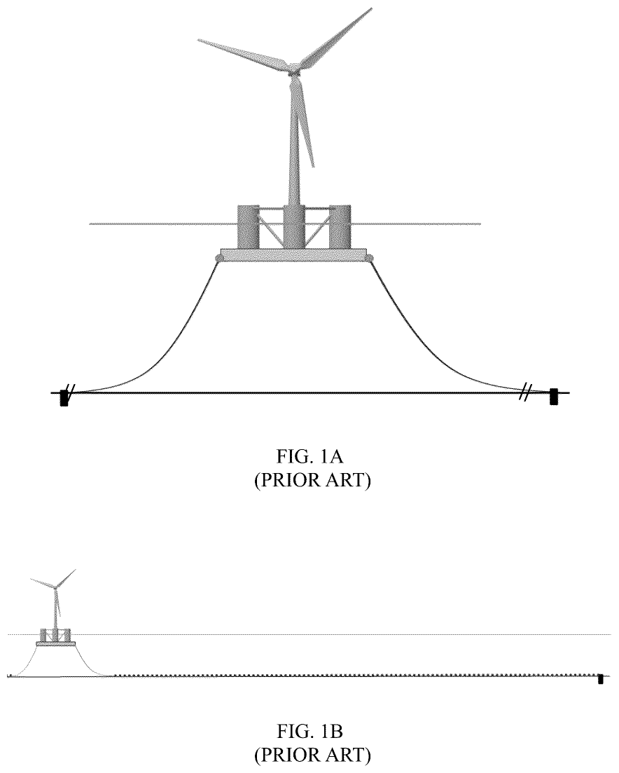

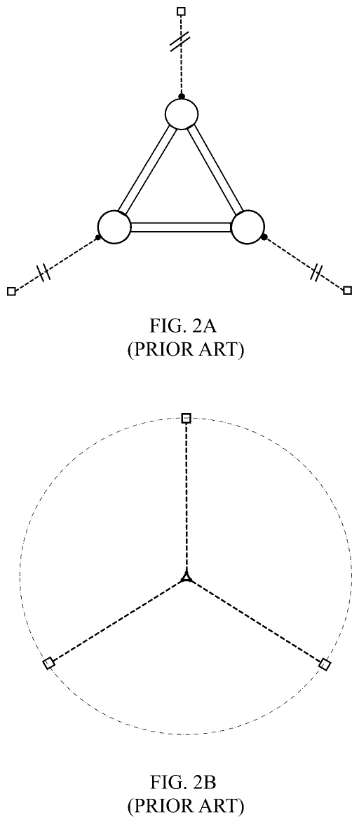

### DETAILED DESCRIPTION OF THE INVENTION

The present invention relates to mooring systems and installation method for station-keeping of a floating offshore wind turbine with a small footprint on the seabed. Before explaining the invention in detail, it is to be understood that the present invention is not limited to the embodiments as disclosed and that it can be practiced or carried out in various ways. It is understood that although the disclosed mooring systems and methods are generally intended for shallow water, they can be used in any body of water not limited by water depth, and with any type of floating bodies not limited to floating offshore wind turbines. In the text, if not specified, the word “offset” means horizontal offset; and “move” means move in horizontal direction. The use of relational terms, such as, but not limited to, “top,” “bottom,” “left,” “right,” “upper,” “lower,” “deeper,” “shallower,” “up,” “down,” “side,” and the like in the written text is for clarity in specific reference to the Figures and is not intended to limit the scope of the invention or the claims.

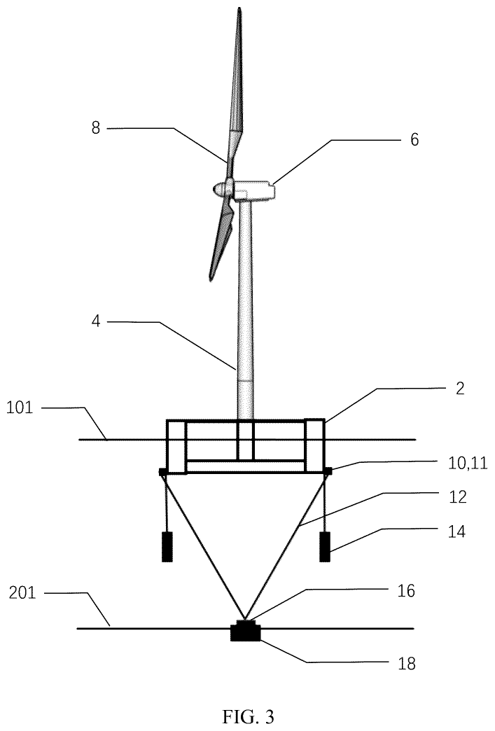

Preferred embodiments of the present invention are shown in FIGS. 3 through 21 with detailed description as follows.

With reference to FIG. 3, a constant tension single shared anchor mooring system for station-keeping of a floating offshore wind turbine with an anchor 18, comprises a floating hull 2 with buoyancy extending above a waterline 101, a wind turbine nacelle and rotor assembly 6, 8 coupled to a top of a turbine tower 4 supported by the floating hull 2 above the waterline 101; a plurality of fairlead devices 10, fairlead supports 11, mooring lines 12 and pendent gravity units 14 each having a submerged weight; an anchor head structure 16 coupled to a top of the anchor 18 on a seabed 201. Each of the fairlead devices 10 is attached to each of the corresponding fairlead supports 11 coupled symmetrically to the floating hull 2; each of the mooring lines 12 has a first segment with a first end attached to each of the corresponding pendent gravity units 14 from which running vertically upward through each of the corresponding fairlead devices 10 then extending downward in a different plane from that of the pendent gravity unit with the first segment of the mooring line to a second end attached to a top of the anchor head structure 16 in a center of a mooring pattern which is an intersection of a vertical centerline of the floating offshore wind turbine and the seabed 201; each of the pendent gravity units 14 is suspended in mid-water below each of the corresponding fairlead devices 10 causing a tension force in each of the corresponding mooring lines equal to the submerged weight the pendent gravity unit. The fairlead device 10 is a three-dimensional fairlead system through which the mooring line 12 changes direction in three dimensions exiting in an offset plane. Specifically, the first end of the mooring line 12 connecting the pendent gravity units 14 is not in the same plane of the second end connecting to the anchor 18. The three-dimensional design of the fairlead device ensures that there is no clashing of the mooring line 12 even though it appears crossing at some point.

The material of the mooring line 12 may be of steel chain, steel wire or synthetic material such as polyester or nylon. The material of the pendent gravity unit 14 may be of steel, iron ore, concrete, or other types of heavy materials. The breaking strength of the mooring line 12 should be determined based on the submerged weight of the pendent gravity unit 14 with a safety factor. The anchor 18 is preferred to be gravity-type or suction-type anchor. If the gravity-type anchor is used, the submerged weight of the gravity anchor 18 should be equal or greater than the sum of the submerged weight of the pendent gravity units 14. If the suction-type anchor is used, the uplift capacity of the suction anchor should be greater than the sum of the submerged weight of the pendent gravity units 14. From economical point of view, a gravity anchor made of concrete material typically costs less than a suction anchor made of steel.

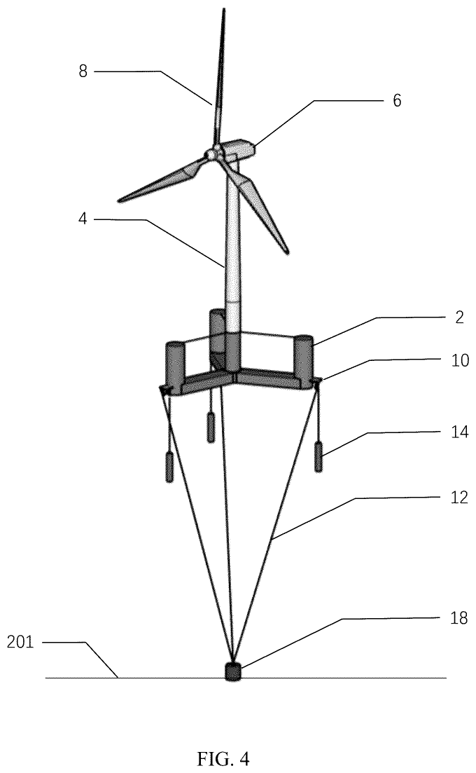

With reference to FIG. 4, the constant tension single shared anchor mooring system shown in FIG. 3 consists essentially of three fairlead devices 10, three mooring lines 12 and three pendent gravity units 14 suspended in mid-water forming a symmetrical mooring pattern with the anchor 18 located in a center of the mooring pattern on the seabed 201; each of the mooring lines 12 runs radially upward and outward from the anchor 18 to each of the corresponding fairlead devices 10 located symmetrically to an outer perimeter of the floating hull 2 supporting the wind turbine system 4, 6, 8.

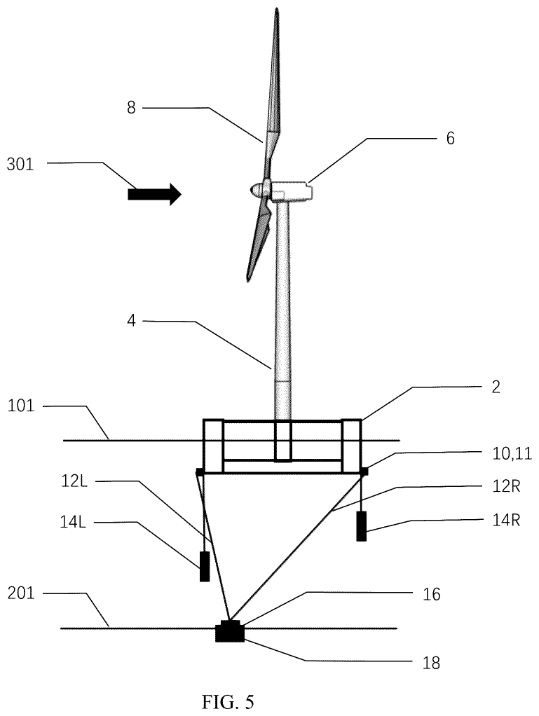

With reference to FIG. 5, a schematic side view of an embodiment of the floating offshore wind turbine with the constant tension single shared anchor mooring system shown in FIG. 3 is illustrated at a maximum horizontal offset position.

The main function of a mooring system is to restrain the position of a floater by providing a horizontal restoring force as the floater moves away (having an offset) from an initial equilibrium position. For simplicity of this description, the constant tension mooring system is illustrated with two mooring lines 12R (right side) and 12L (left side), two fairlead devices 10R and 10L, two pendent gravity units 14R and 14L each having a submerged weight and one anchor head structure 16 in a two-dimensional arrangement as shown in FIG. 5. The mooring line 12R has a length between the fairlead device 10R and the anchor head structure 16. This length increases and the corresponding pendent gravity unit 14R moves up to an upper limit below the fairlead 10R when the floating hull 2 moves in a right direction to the maximum horizontal offset position from the anchor 18 under a wind load 301. In the meantime, the mooring line 12L in an opposite direction of the mooring line 12R has a length between the fairlead 10L and the anchor head structure 16, and this length decreases and the corresponding pendent gravity unit 14L moves down to a lower limit above the seabed 201 as the fairlead 10L moves in the right direction with the floating hull 2. The mooring line tension forces of the mooring lines 12R and 12L remain constant equal to the submerged weight of the pendent gravity units 14R and 14L, respectively; due to the pulley principle. Each of the mooring lines 12R and 12L has a corresponding mooring angle with respect to the waterline 101. The mooring angle becomes smaller for the mooring line 12R and larger for the mooring line 12L. This gives a larger horizontal component force for the mooring line 12R and smaller horizontal component force for the mooring line 12L than the respective initial horizontal forces at the initial equilibrium position. The mooring system restoring force is a resultant force of the horizontal component forces of the mooring line tension forces in mooring lines 12R and 12L.

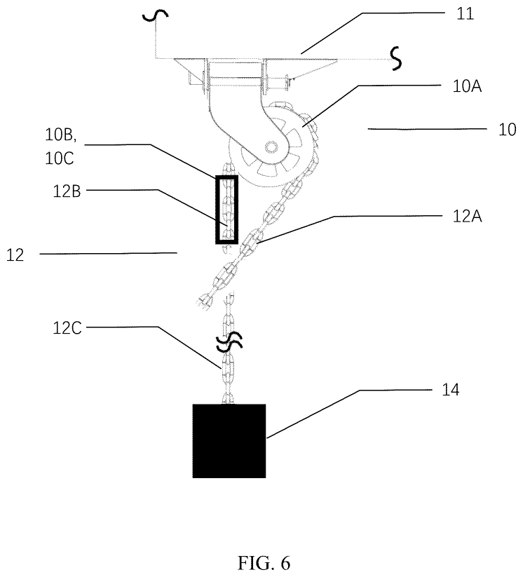

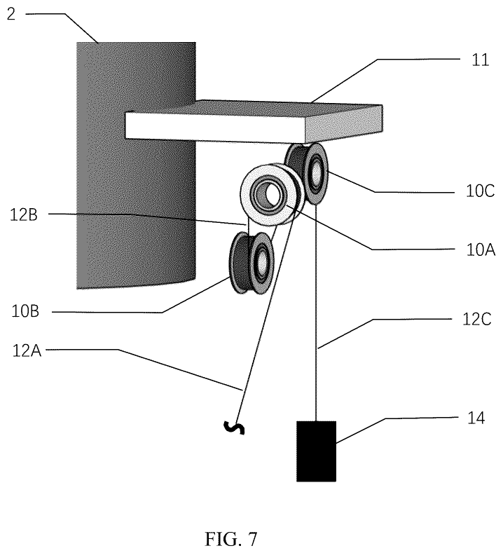

With reference to FIG. 6, the three-dimensional fairlead device 10 attached to the fairlead support 11 comprises three fairlead wheels, 10A, 10B (detail not shown for clarity), 10C (not shown, behind 10B), each with a grooved rim around which the mooring line 12, having three segments 12A, 12B, 12C, runs through from one side 12A to another side 12B and acts to change a direction of a tension force applied to the mooring line 12 while maintaining a constant magnitude of the tension force. The magnitude of the tension force of the mooring line 12 on both sides of each of the wheels 10A, 10B, 10C, equals to the submerged weight of the pendent gravity unit 14 suspended vertically in mid-water. The mooring line segment 12B runs in a direction into a perpendicular plane to that of wheel 10A, through wheels 10B (below and behind 10A in an offset space) and 10C (not shown, behind 10B), first changing direction into the perpendicular plane through wheel 10B, then through wheel 10C changing to a downward direction with mooring line segment 12C connecting to the pendent gravity unit 14. This is better illustrated in a three-dimensional perspective view with reference to FIG. 7. The three-dimensional fairlead device 10 comprising the three fairlead wheels 10A, 10B, 10C, is coupled to the fairlead support 11 (details not shown for clarity) attached to the floating hull 2. The mooring line segment 12A runs upward through a first fairlead wheel 10A turning down to a second fairlead wheel 10B (below and behind 10A in an offset space) with the mooring line segment 12B, which changes into a direction perpendicular to the plane of the first fairlead wheel 10A. The mooring line segment 12B runs upward through a third fairlead wheel 10C in the same plane then turning down to mooring line segment 12C connecting to the pendent gravity unit 14. Since the plane of the third fairlead wheel 10C is perpendicular to the plane of the first fairlead wheel 10A, the distance between the first fairlead wheel 10A and the third fairlead wheel 10C is set long enough to keep the mooring line 12A and 12C from clashing with each other in three-dimensional space as the floating hull moves to offset positions.

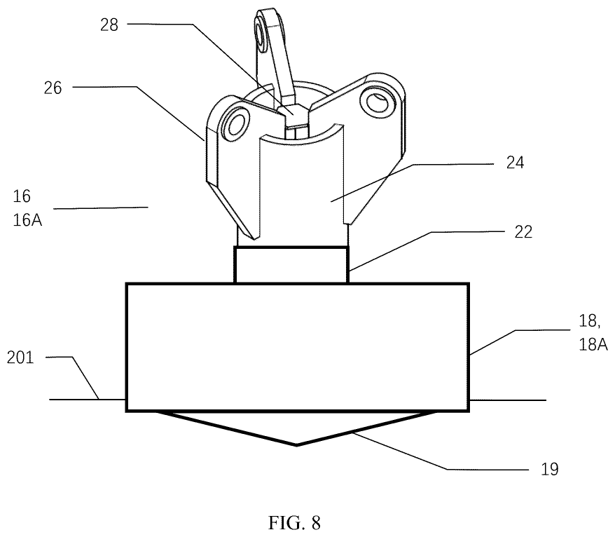

With reference to FIG. 8, the anchor 18 is a gravity anchor comprising an anchor head structure 16, a large block structure 18A with a cone structure 19 at a bottom embedded below the seabed 201. The large block structure 18A and the cone structure 19 are solid structures made of high-density concrete with a circular or square cross section. The anchor head structure 16 is made of steel having a padeye assembly 16A at a top and a transition piece 22 coupled to a top of the anchor block structure 18A at a bottom: The padeye assembly 16A comprises a tubular section 24 coupled to the transition piece 22 at a bottom, a plurality of anchor padeyes 26 coupled to a top of the tubular section 24, and a plurality of link plates 28 connecting the anchor padeyes 26. Specifically, for the constant tension single shared anchor mooring system having three mooring lines as shown in FIG. 4, there will be three mooring padeyes 26 symmetrically located at a top of the anchor 18.

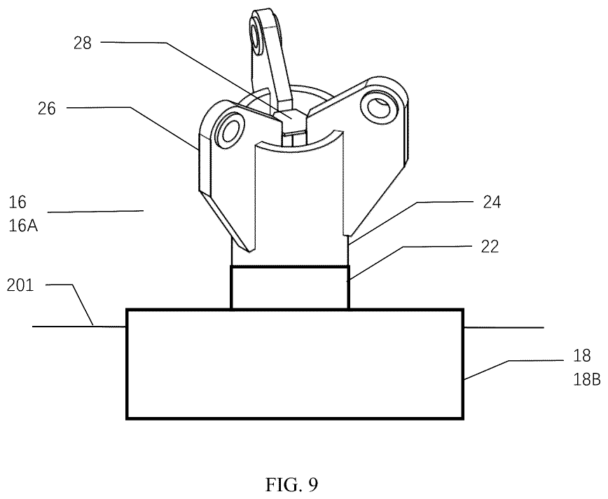

With reference to FIG. 9, the anchor 18 is a steel suction anchor comprising an anchor head structure 16, a large diameter suction bucket structure 18B mostly embedded below the seabed 201. The anchor head structure 16 is made of steel having a padeye assembly 16A at a top and a transition piece 22 coupled to a top of the suction bucket structure 18B at a bottom: The padeye assembly 16A comprises a tubular section 24 coupled to the transition piece 22 at a bottom, a plurality of anchor padeyes 26 coupled to a top of the tubular section 24, and a plurality of link plates 28 connecting the anchor padeyes 26. For the constant tension single shared anchor mooring system with three mooring lines as shown in FIG. 4, there will be three anchor padeyes 26 symmetrically located at the top of the anchor 18.

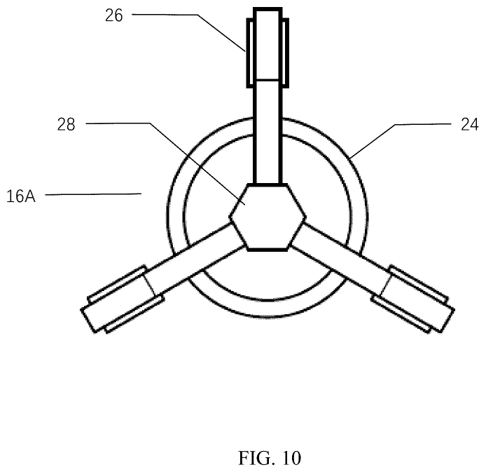

With reference to FIG. 10, a detailed top view of the padeye assembly 16A as shown in FIG. 9 includes three anchor padeyes 26 arranged symmetrically on a top of the tubular section 24 connected by the ink plates 28.

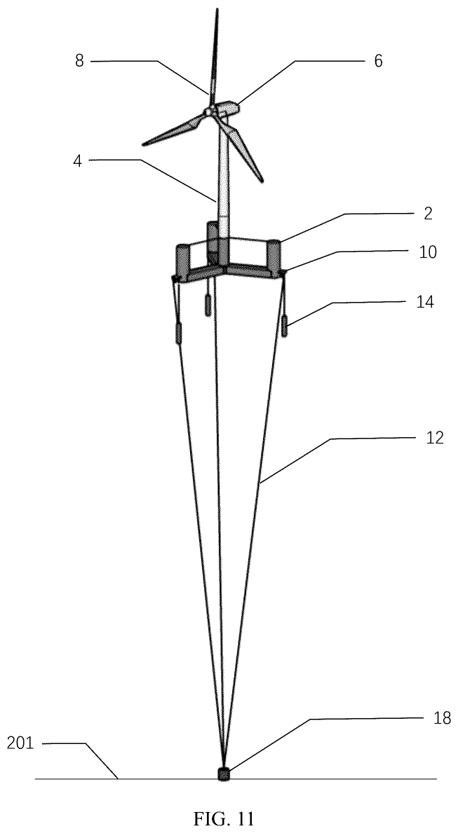

With reference to FIG. 11, another embodiment of the constant tension single shared anchor mooring system in deep water consists essentially of three fairlead devices 10, fairleads supports 11, mooring lines 12 and pendent gravity units 14 forming a symmetrical mooring pattern with the anchor 18 located in a center of the mooring pattern on the seabed 201: each of the mooring lines 12 runs radially outward from the anchor 18 to each of the corresponding fairlead devices 10 attached to each of the corresponding fairlead supports 11 coupled symmetrically to an outer perimeter of the floating hull 2 extending radially outward.

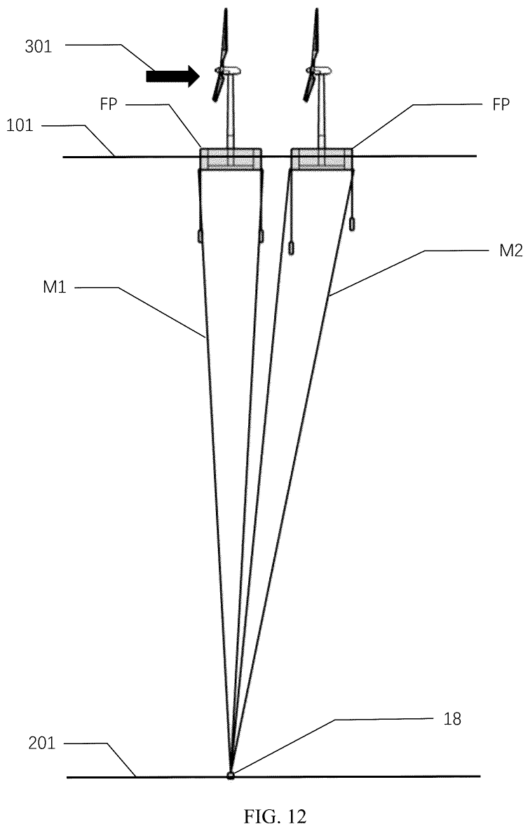

With reference to FIG. 12, a floating offshore wind turbine platform FP is illustrated floating on a waterline 101 in a deep water at an initial equilibrium position with a constant tension single shared anchor mooring system M1 having a gravity anchor 18 on a seabed 201. Under a wind load 301, The floating offshore wind turbine platform FP moves from the initial equilibrium position to an offset position with the constant tension single shared anchor mooring system changing configuration from M1 to M2. At the offset position, a new equilibrium for the floater FP is achieved with the M2 configuration having a sum horizontal restoring force from the mooring lines in opposite direction of the wind force 301 with the same magnitude.

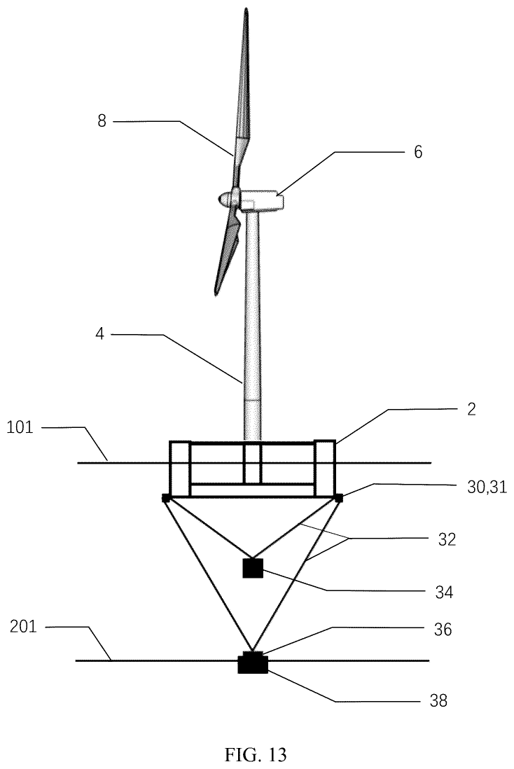

With reference to FIG. 13, an interconnected lines single shared anchor mooring system for station-keeping of a floating offshore wind turbine, comprises a floating hull 2 with buoyancy extending above a waterline 101, a wind turbine nacelle and rotor assembly 6, 8 coupled to a top of a turbine tower 4 supported by the floating hull 2 above the waterline 101; a plurality of mooring fairleads 30, fairlead supports 31, mooring lines 32, and one pendent gravity unit 34 having a submerged weight; an anchor head structure 36 coupled to a top of an anchor 38 on a seabed 201. Each of the fairlead devices 30 is attached to each of the corresponding fairlead supports 31 coupled symmetrically to an outer perimeter of the floating hull 2 extending a distance radially outward; each of the mooring lines 32 has a first end attached to each of the corresponding pendent gravity unit 34 from which running radially upward through each of the corresponding mooring fairleads 30 then extending radially downward to a second end attached to a top of the anchor head structure 16 in a center of a mooring pattern which is an intersection of a vertical centerline of the floating offshore wind turbine and the seabed 201. The mooring lines 32 are interconnected at the pendent gravity units 34 which is suspended in mid-water directly above the anchor 38 on the seabed.

The details of the anchor 38 are the same as the constant tension single shared anchor mooring system described earlier in this text.

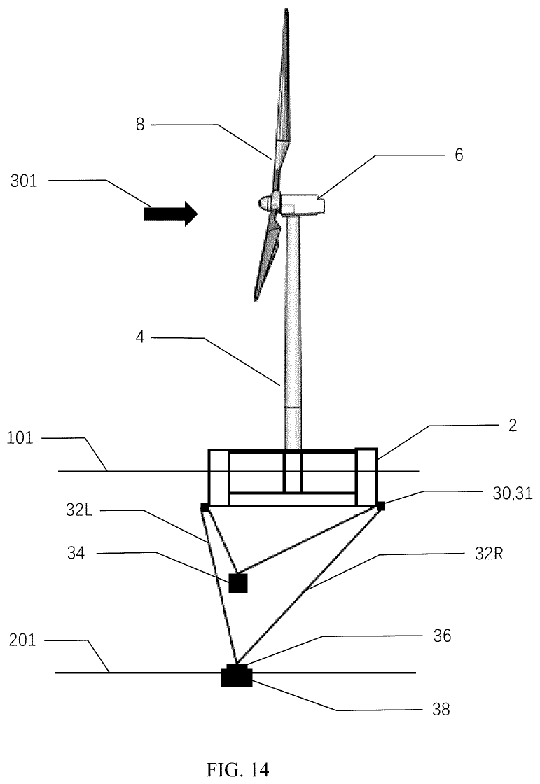

With reference to FIG. 14, a schematic side view of an embodiment of the floating offshore wind turbine with the interconnected lines single shared anchor mooring system as shown in FIG. 13 is illustrated at a maximum horizontal offset position. For simplicity of this description, the interconnected lines single shared anchor mooring system is illustrated with two mooring lines 32R (right side) and 32L (left side), two mooring fairleads 30R and 30L in a two-dimensional arrangement. The two mooring lines 32R and 32L each having an outer segment from a corresponding fairleads 30R and 30L, respectively, to the anchor head structure 36, and an inner segment from each of the corresponding fairlead to the pendent gravity units 34 forming an interconnected mooring system. At the initial equilibrium position, the mooring line 32R has an outer segment length equal to that of the mooring line 32L. The outer segment length increases for line 32R and decreases for line 32L when the floating hull 2 moves in a right direction to the maximum horizontal offset position under a wind load 301. The inner segment length of the mooring line length for the mooring line 32R and 32L, respectively, will also change, but the total length of the two mooring lines will remain not changed. This forms a shared mooring line system wherein the outer segments provide the effective restoring force when the floating hull 2 is in an offset position while the inner segments with the interconnected pendent gravity unit 34 and fairleads 30R and 30L provide a mechanism for varying the effective mooring line length and tension in the outer segments of the mooring lines 32R and 32L. Specifically, the pendent gravity unit 34 moves up and to the left relative to its initial position when the floating hull 2 moves to the right, and the two mooring lines 32R and 32L having different tension forces and mooring angles with respect to the waterline 101. The sum of the mooring line tension forces of the mooring lines 32R and 32L at the interconnection point with the pendent gravity unit 34 in the vertical direction equals to the submerged weight of the pendent gravity unit 34. The mooring angle of the outer segment becomes smaller for the mooring line 32R and larger for the mooring line 32L. This gives a larger horizontal component force for the mooring line 32R and smaller horizontal component force for the mooring line 32L than the respective initial horizontal forces at the initial equilibrium position. The effective mooring system restoring force is a resultant force of the horizontal component forces of the mooring line tension forces in the outer segments of mooring lines 32R and 32L. The horizontal component forces of the mooring line tension forces in the inner segments of the mooring lines 32R and 32L balance each other as they are internal forces of the mooring system according to physics determining the position (horizontal and vertical) of the pendent gravity unit 34 relative to its initial position.

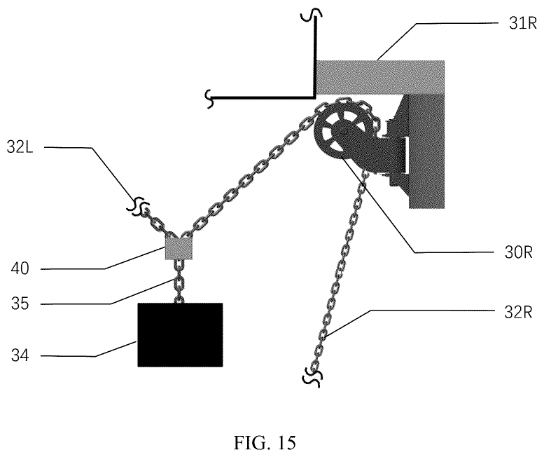

With reference to FIG. 15, the mooring fairlead 30R attached to the fairlead support 31R comprises a wheel with a grooved rim around which the mooring line 32R runs through from one side connecting to the pendent gravity unit 34 to another side to the anchor (not shown) acting to change a direction of a tension force applied to the mooring line 32R while maintaining a constant magnitude of the tension force. The mooring line 32R is interconnected with the mooring line 32L at a mooring connection device 40 to which the pendent gravity unit 34 is also connected by a link chain 35 hanging below in mid-water. The magnitude of the tension force of the mooring line 32R is not constant as it dependent on not only the submerged weight of the pendent gravity unit 34, but also the geometry or configuration of the interconnected inner segments of the mooring lines 32R and 32L. For example, at the initial position, the two mooring lines 32R and 32L have a symmetrical configuration with a same angle. Assuming the initial horizontal mooring angle of the inner segment is 30 degrees, the tension force in each of the two mooring lines 32R and 32L will equal to the submerged weight of the pendent gravity unit. When this inner mooring angle decreases, the mooring line tension forces will increase, i.e., the mooring system is getting tighter, and vice versa. Therefore, both the weight of the pendent gravity unit and the initial inner mooring angle are the determining factors for the station-keeping effectiveness of the mooring system.

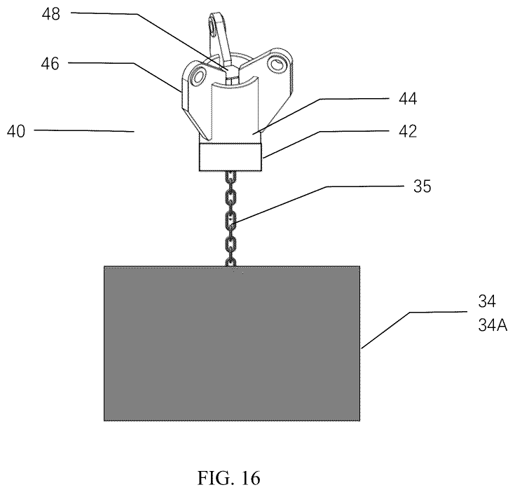

With reference to FIG. 16, the pendent gravity unit 34 comprises a large block structure 34A with the link chain 35 at a top connecting to the mooring connection device 40. The large block structure 35A is preferred to be a solid structure made of high-density concrete with a circular or square cross section. The mooring connection device 40 is made of steel having a transition piece 42 coupled to a top end of the link chain 35 at a bottom and a mooring padeye assembly at a top which comprises a tubular section 44 coupled to the transition piece 42 at a bottom, and a plurality of mooring padeyes 46 at a top, with a plurality of link plates 48 connecting the mooring padeyes 46. Specifically, for the interconnected mooring system having three mooring lines, there will be three mooring padeyes 46 symmetrically located at a top of the mooring connection device 40.

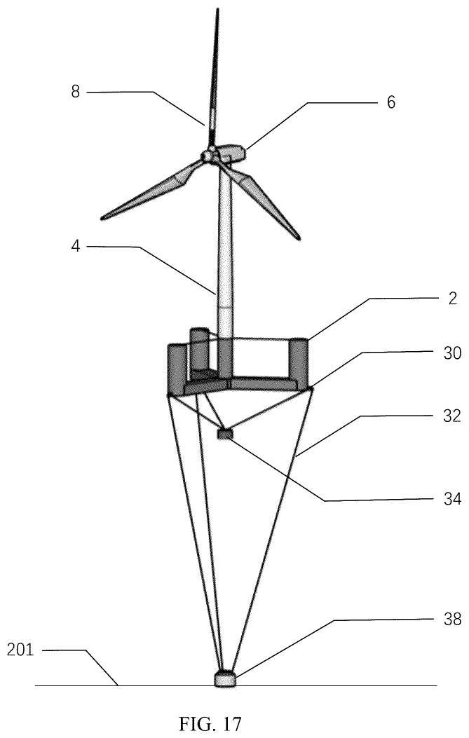

With reference to FIG. 17, the interconnected lines single shared anchor mooring system shown in FIG. 13 consists essentially of three mooring fairleads 30, three fairlead supports 31, three mooring lines 32 and one pendent gravity unit 34 suspended in mid-water below the floating hull 2 forming a symmetrical mooring pattern with the anchor 38 located in a center of the mooring pattern on the seabed 201: each of the mooring lines 32 runs radially upward from a first end at the anchor 38 to each corresponding one of the mooring fairleads 30 located symmetrically on the floating hull 2 supporting the wind turbine system 4, 6, 8, and extends downward to a second end attached to the pendent gravity unit suspended in mid-water below the floating hull 2.

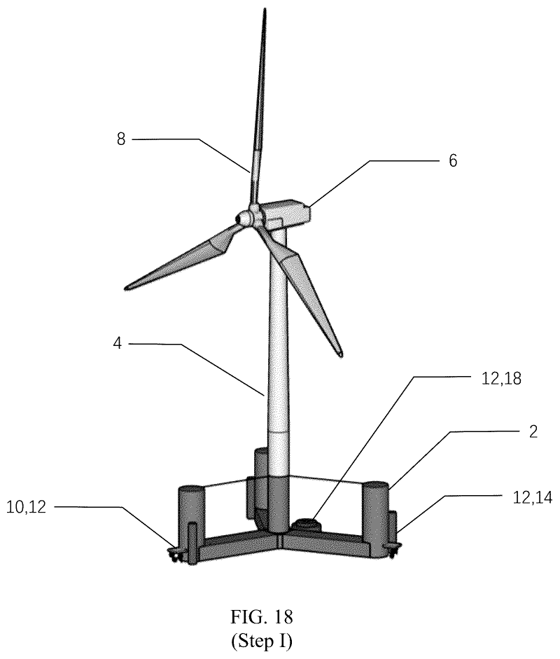

With reference to FIG. 18, a method for installing a single shared anchor mooring system is illustrated. In some embodiments, a Step I of the installation method is connecting the mooring lines 12 (not shown for clarity) through each of the corresponding fairlead devices 10 to the anchor 18 and each of the corresponding pendent gravity units 14, and secure the entire mooring system to the floating hull 2 support the wind turbine system 4, 6, 8 at quayside using temporary sea-fastening (not shown for clarity) wherein each of the pendent gravity units 14 is located close to each of the corresponding fairlead devices 10, and the anchor 18 is located close to the center of the floating hull 2.

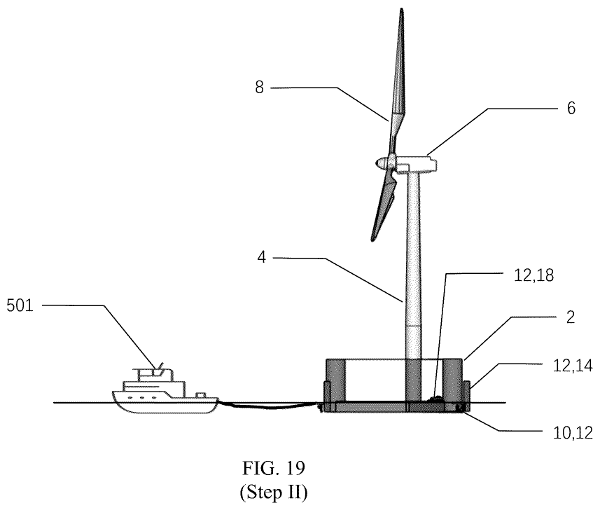

With reference to FIG. 19, in some embodiments, a Step II of the installation method is sea-towing of the entire assembly of the floating hull 2 with the wind turbine system 4, 6, 8 and the mooring system 10, 12, 14, 18 by a tugboat 501 to an offshore wind farm site.

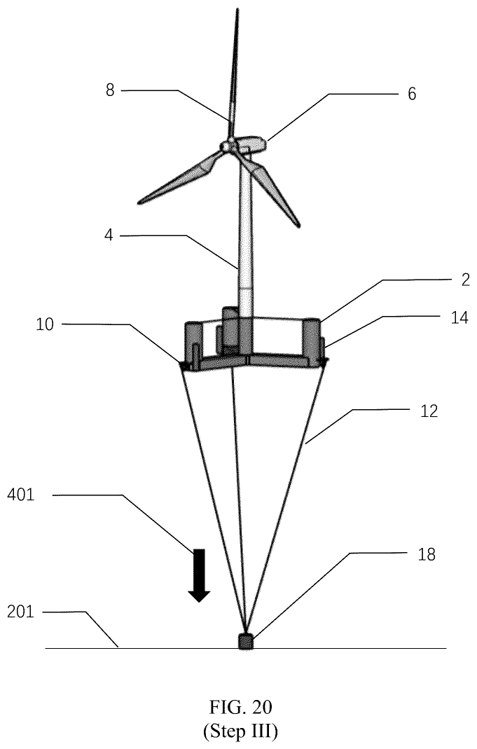

With reference to FIG. 20, in some embodiments, a Step III of the installation method is releasing the sea-fastening (not shown for clarity) and lowering the anchor 18 under gravity to the seabed 201 from the floating hull 2 with the wind turbine system 4, 6, 8 at the offshore wind farm site, wherein the mooring lines 12 are connected to each of the corresponding pendent gravity units 14 and the anchor 18 through each of the corresponding fairlead devices 10.

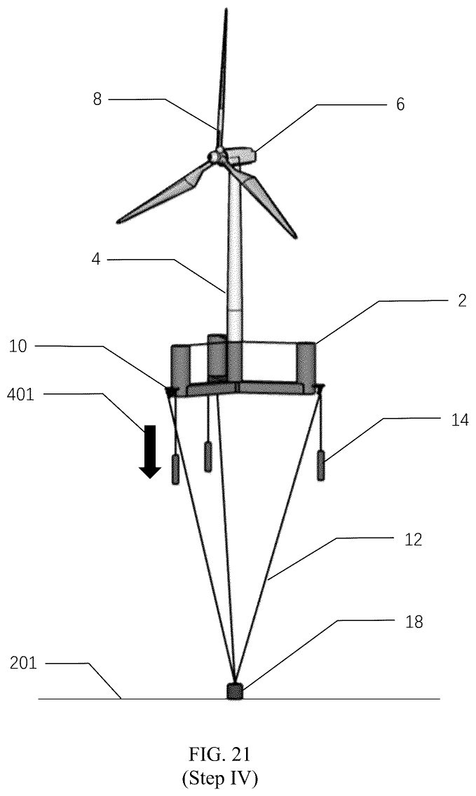

With reference to FIG. 21, in some embodiments, a Step IV of the installation method is releasing the sea-fastening (not shown for clarity) and lowering each of the pendent gravity units 14 under gravity to mid-water at the offshore wind farm site, wherein each of the mooring lines 12 are connected to each of the corresponding pendent gravity units 14 and the anchor 18 on the seabed 201 through each of the corresponding fairlead devices 10 attached to the floating hull 2 with the wind turbine system 4, 6, 8. During the lowering process, each of the mooring lines 12 is automatically tightened under gravity with the mooring line tension equal to the submerged weight of the corresponding pendent gravity unit 14.

The installation method described above uses the specific elements of the constant tension single shared anchor mooring systems. However, it is not difficult to see the installation method can also be readily used for the interconnected lines single shared anchor mooring system. Specifically, the installation steps are practically the same, i.e., the anchor is lowered first to the seabed with the mooring lines connected, then the pendent gravity unit is lowered to mid-water with each of the interconnected mooring lines through each of the corresponding fairleads.

The above descriptions and figures are exemplary embodiments of the present invention and preferred main points of the mooring systems and installation method for floating offshore wind turbines in water depth range generally between 50 and 1500 meters. However, the mooring systems are not limited to 1500 meters water depth and can be deployed to 2000 meters water depth and beyond for all types of floating systems, not limited to floating offshore wind turbines. All modifications, equivalents, and alternatives to the above preferred embodiments are to be covered in the character and scope of the present invention.

What is claimed is:

1. A mooring system for station-keeping of a floating offshore wind turbine, comprising:
an anchor fixed to a seabed;
a floating hull having an upper part supporting a wind turbine above a waterline and a lower part below the waterline;
a plurality of pendent gravity units each having a submerged weight;
a plurality of three-dimensional fairlead devices;
a plurality of mooring lines, wherein each of the mooring lines having a first segment with a first end attached to a corresponding one of the pendent gravity units from which running vertically upward through a corresponding one of the three-dimensional fairlead devices attached to the floating hull then extending downward in a different plane from that of the pendent gravity unit with the first segment of the mooring line to a second end attached to the anchor, wherein each of the mooring lines having a constant tension force equal to the submerged weight of the corresponding one of the pendent gravity units suspended in mid-water, wherein the pendent gravity units move upward or downward when the floating hull having a horizontal offset from an initial position.

2. The system of claim 1, wherein having a plurality of fairlead supports and anchor padeyes, and an anchor head structure coupled to a top of the anchor, wherein having each of the three-dimensional fairlead devices coupled to a corresponding one of the fairlead supports symmetrically coupled to the lower part of the floating hull, and each of the anchor padeyes symmetrically coupled to the anchor head structure.

3. The system of claim 1, wherein consisting essentially of at least three mooring lines, three three-dimensional fairlead devices, three pendent gravity units, three anchor padeyes and three fairlead supports forming a symmetrical mooring pattern, wherein each mooring line having a first segment with a first end attached to a corresponding one of the pendent gravity units suspended below each of a corresponding one of the three-dimensional fairlead devices coupled to each of a corresponding one of the fairlead supports from which running vertically upward through the corresponding three-dimensional fairlead device then extending downward in a different plane from that of the pendent gravity unit with the first segment of the mooring line to a second end connected to a corresponding one of the anchor padeyes symmetrically coupled to a top of the anchor head structure in a center of the mooring pattern which is an intersection of a vertical centerline of the floating hull and the seabed.

4. The system of claim 1, wherein each of the three-dimensional fairlead devices having three fairlead wheels each having a grooved rim around which each of the corresponding mooring lines runs through from a first side to a second side acting to change a direction of the mooring line while maintaining a constant magnitude of the tension force of the mooring line, wherein the magnitude of the tension force of the mooring line on both sides of the fairlead wheel equal to the submerged weight of the corresponding pendent gravity unit.

5. The system of claim 4, wherein each of the mooring lines runs upward radially from the anchor, through a first fairlead wheel and turns down to a second fairlead wheel, and changes into a direction perpendicular to the plane of the first fairlead wheel, wherein the mooring line exits the second fairlead wheel from below and runs upward in a plane of the second fairlead wheel through a third fairlead wheel and turns down and connects to the pendent gravity unit.

6. The system of claim 1, wherein having each of the pendent gravity units consisting essentially of a large solid block made of concrete or steel or other heavy materials with a cross section of square, circle, rectangle, or other shapes.

7. The system of claim 1, wherein having the anchor head structure consisting essentially of an upper section and a lower section, wherein having the lower section with an adjustable length coupled to the top of the anchor, wherein having the upper section comprising a tubular pipe with each of the anchor padeyes coupled symmetrically to a top of the tubular pipe, wherein a plurality of link plates connecting the padeyes inside the tubular pipe.

8. The system of claim 1, wherein the mooring line can be of steel chain, steel wire or synthetic rope such as polyester or nylon or a combination thereof.

9. The system of claim 1, wherein the anchor can be of a suction type made of steel mostly embedded into the seabed, or a gravity type, wherein the gravity type anchor comprising a large solid block with a cone structure at a bottom embedded into the seabed. The large block and the cone structure are made of high-density concrete with a circular or square cross section.

10. A mooring system for station-keeping of a floating offshore wind turbine, comprising:
an anchor fixed to a seabed;
a floating hull having an upper part supporting a wind turbine above a waterline and a lower part below the waterline;
a pendent gravity unit having a submerged weight;
a plurality of mooring fairleads;
a plurality of mooring padeyes;
a mooring connection device comprising the mooring padeyes;
a link chain connecting the mooring assembly to the pendent gravity unit;
a plurality of mooring lines interconnected at the mooring connection device, wherein each of the mooring lines having a first end attached to a corresponding one of the mooring padeyes attached to the mooring assembly from which running radially upward through a corresponding one of the mooring fairleads attached to the floating hull then extending downward to a second end attached to the anchor, wherein each of the mooring lines having a varying tension force, wherein a sum of vertical component forces of tension forces of the interconnected mooring lines at the mooring connection device equal to the submerged weight of the pendent gravity unit suspended in mid-water, wherein the pendent gravity unit moves in three dimensions when the floating hull having a horizontal offset from an initial position.

11. The system of claim 10, wherein having a plurality of fairlead supports and anchor padeyes, and an anchor head structure coupled to a top of the anchor, wherein having each of the mooring fairleads coupled to a corresponding one of the fairlead supports symmetrically coupled to the lower part of the floating hull, and each of the anchor padeyes symmetrically coupled to the anchor head structure.

12. The system of claim 10, wherein consisting essentially of at least three mooring lines, three mooring fairleads, three anchor padeyes, and three fairlead supports forming a symmetrical mooring pattern, wherein the mooring lines are interconnected at the mooring connection device, wherein each of the mooring lines having a first end attached to a corresponding one of the mooring padeyes from which running radially upward through a corresponding one of the mooring fairleads attached to the floating hull then extending downward to a second end attached to a corresponding one of the anchor padeyes coupled to the anchor head structure coupled to the anchor located on the seabed, wherein each of the mooring lines having a varying tension force, wherein a sum of vertical component forces of tension forces of the interconnected mooring lines equal to the submerged weight of the pendent gravity unit suspended in mid-water, wherein the pendent gravity unit move in three dimensions when the floating hull having a horizontal offset from an initial position.

13. The system of claim 10, wherein the mooring connection device is made of steel material comprising a transition piece coupled to an upper end of the link chain at a bottom and a mooring padeye assembly at a top, wherein the mooring padeye assembly comprising a tubular section coupled to the transition piece at a bottom and the mooring padeyes symmetrically located at a top, and a plurality of link plates connecting the mooring padeyes inside the tubular section, wherein the link chain connects the pendent gravity unit at a lower end.

14. The system of claim 10, wherein the pendent gravity unit consisting essentially of a large solid block made of concrete or steel or other heavy materials with a cross section of square, circle, rectangle, or other shapes.

15. A method for installing the constant tension single shared anchor mooring system with the floating hull, comprising the steps of:
Step I, connecting the mooring lines through each of the corresponding fairlead devices to the anchor and each of the corresponding pendent gravity units, and secure the entire mooring system assembly to the floating hull at quayside using temporary sea-fastening, wherein each of the pendent gravity units located close to each of the corresponding fairlead devices attached to the floating hull, and the anchor located close to the center of the floating hull;
Step II, sea-towing of the entire assembly of the floating hull with the entire mooring system assembly by a tugboat to an offshore wind farm site.

16. The method of claim 15, further comprising the steps of:
Step III, releasing the sea-fastening and lowering the anchor under gravity to the seabed from the floating hull at the offshore wind farm site, wherein the entire mooring line assembly secured to the floating hull by sea-fastening;
Step IV, releasing the sea-fastening and lowering each of the pendent gravity units under gravity to mid-water at the offshore wind farm site, wherein each of the mooring lines connected to each of the corresponding pendent gravity units and the anchor on the seabed through each of the corresponding fairlead devices attached to the floating hull, wherein during the lowering process, each of the mooring lines automatically tightened under gravity, wherein a mooring line tension of each of the mooring lines equal to a submerged weight of the corresponding pendent gravity unit.
